(19) United States
(12) Patent Application Publication
(10) Pub. No.: US 2006/0170954 A1
(43) Pub. Date: Aug. 3, 2006

(54) Method and system for generating synchronous multidimensional data streams from a one -dimensional data stream

(75) Inventor: Evigeniy Leyvi, Riverdale, NY (US)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/548,704

(22) PCT Filed: Mar. 2, 2004
(86) PCT No.: PCT/IB04/00615

§ 371 Date: Sep. 8, 2005

Related U.S. Application Data
(60) Provisional application No. 60/453,754, filed on Mar. 11, 2003.

(51) Int. Cl. G06F 3/12

(52) U.S. Cl. 358/1.15

(57) ABSTRACT

A hardware approach and methodology for receiving one dimensional pixel data stream of scanned lines of a video frame and simultaneously generating therefrom two dimensional parallel data used for real-time video processing in video systems. The parallel data comprise vertical, horizontal and diagonal pixel data centered on a current pixel and included in a window centered on the said pixel.

The present invention relates to video processing systems for display devices, preferably, and particularly a hardware approach and methodology for receiving one dimensional pixel data stream of scanned lines of a video frame and simultaneously generating therefrom multi dimensional data used for real-time video signal processing (e.g. edge detection calculations) in video systems.

Many video processing algorithms require calculations performed within a rectangular block of pixels, moving in the direction of the scan, around a ‘base’ pixel on a pixel by pixel basis, meaning that the results of those calculations each have the rate equal to the incoming pixel stream rate. Most often the calculations are done in two directions: horizontal and vertical (so called, two 1D), but the newest algorithms need calculations performed in diagonal directions +45 and −45 degrees. These algorithms are called full 2D and are utilized, for example, for edge detection and sharpness enhancement functionality.

When the calculations are done in software (during simulation, for example, when the performance speed is not a main consideration), a video frame including a ‘base’ pixel is stored in memory and the calculations most often are done using single or nested ‘FOR’ loops. An index or expression, controlling the performance of the loop, changes typically from 0 to the number, equal to the ‘size of the block −1’ in any particular direction of interest. Software calculations however, do not allow several processes to run in parallel on one processor. Consequently, the calculations are done sequentially and not in real time.

Hardware approaches that include a system for edge detection exist, however they operate in 1 Dimension, (1D), and process data serially.

It would be highly desirable to implement a purely hardware approach that allows several processes to run in parallel, preferably, in two dimensions. A hardware implementation of video algorithms enables real time performance of many processes, thus enabling real-time sharpness enhancement with edge detection, for example, in two (2) dimensions.

It is thus an object of the implement a purely hardware approach that allows several processes to run in parallel, preferably, in two dimensions, from a one-dimensional data stream. A hardware implementation of video algorithms enables real time performance of many processes, thus enabling real-time sharpness enhancement with edge detection, for example, in two (2) dimensions, at increased processing speed. The hardware approach enables real-time block-based 2D video processing performed by parallel operating hardware blocks each calculating on one direction of pixels.

According to the principles of the invention, there is provided a hardware apparatus for real time processing of video images comprising:

means for receiving successive scanned lines of video data of a video frame to be displayed, each received line of video data comprising a one-dimensional stream of pixel data, and a predetermined number M of pixels from each of N successive lines forming a two-dimensional kernel that includes a horizontal base line including a base pixel;

vertical data processing means for successively storing pixel data from said successively received lines of a kernel and generating for successive output N pixel data in parallel form, said N parallel pixel data generated comprising vertically aligned pixel data from each said N lines including a vertical line of pixel data from said kernel including said base pixel;

horizontal data processing means for successively receiving pixel data from a single line of each successive vertically aligned parallel pixel data output from said vertical data processing means, said received pixel data corresponding to said base line including said base pixel, said horizontal data processing means generating for successive output M pixel data in parallel form comprising pixel data belonging to a horizontal base line of said kernel;

diagonal data processing means for successively receiving pixel data from each successive vertically aligned parallel pixel data output from said vertical data processing means and generating for successive output (in general the number of pixels in the diagonal will be the smallest of M and N) pixel data in parallel form comprising pixel data belonging to first and second diagonals of said kernel, said first and second diagonal including said base pixel; and,

timing means for enabling synchronized output of a vertical line parallel data, horizontal base line parallel data and first and second diagonal parallel data each comprising said base pixel of said kernel, to enable subsequent real-time edge detection of a video image at said base pixel.

The objects, features and advantages of the present invention will become apparent to one skilled in the art, in view of the following detailed description taken in combination with the attached drawings, in which:

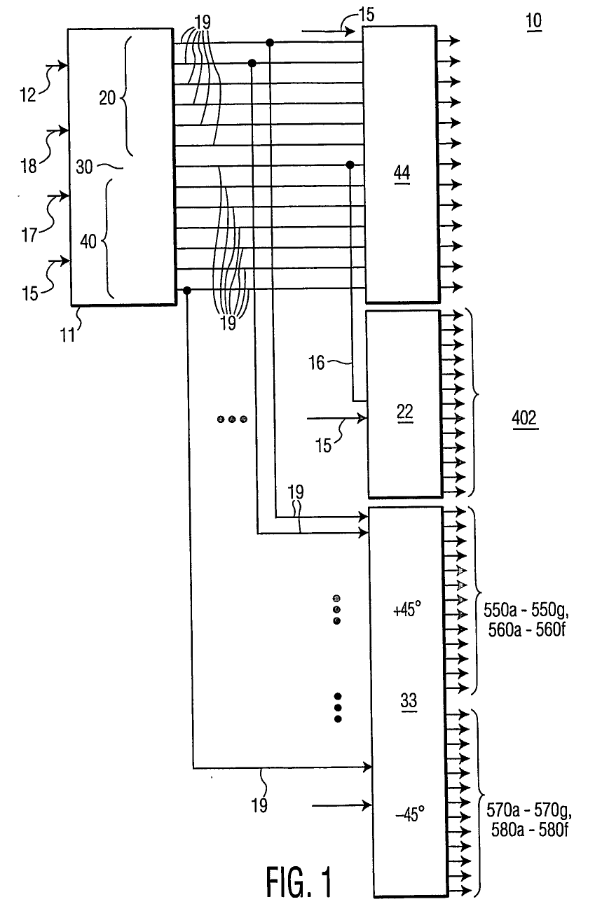

FIG. 1 depicts a generic block diagram 10 of the hardware approach for real time 2D video processing 10 according to the invention;

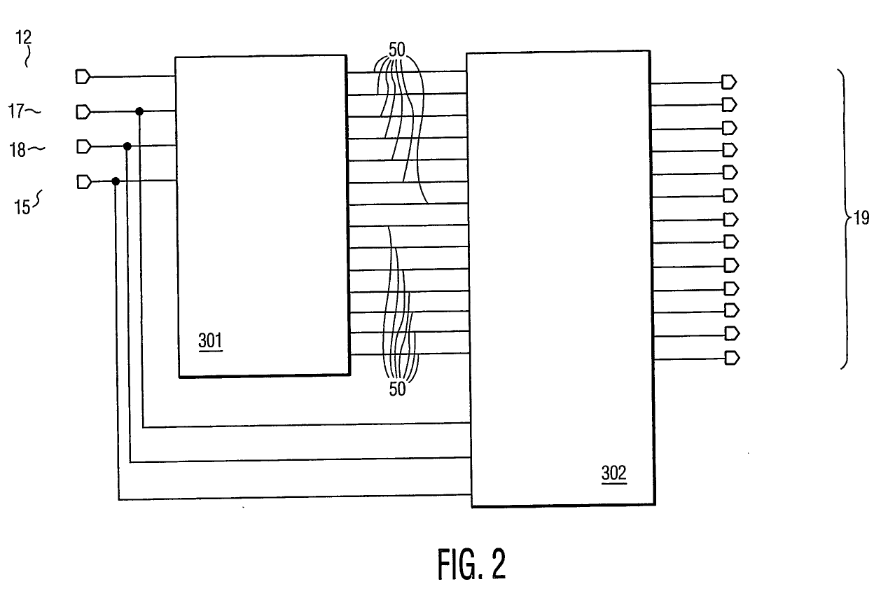

FIG. 2 is a circuit diagram depicting components of the vertical source block ‘11’ depicted in FIG. 1;

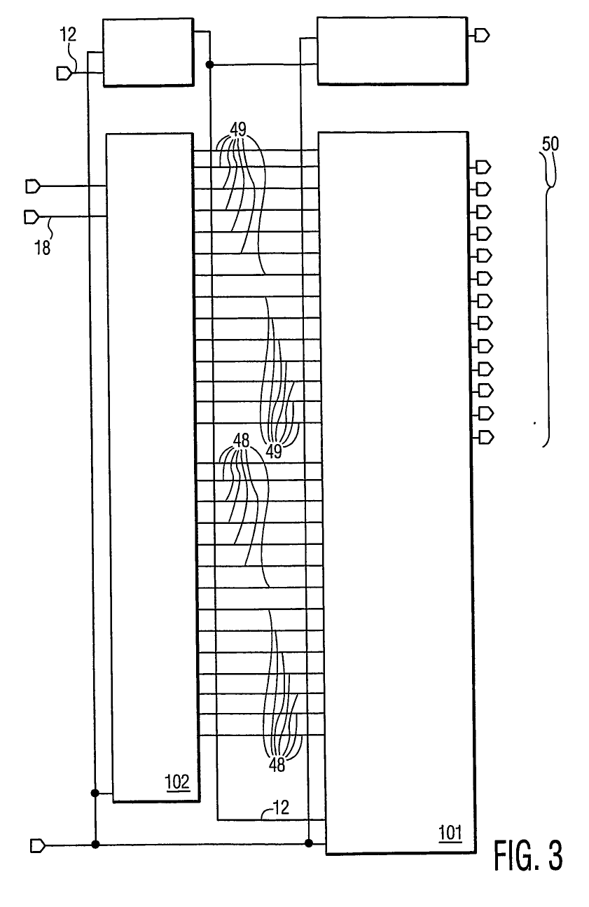

FIG. 3 is a circuit diagram depicting components of the vertical delay block ‘301’ depicted in FIG. 2;

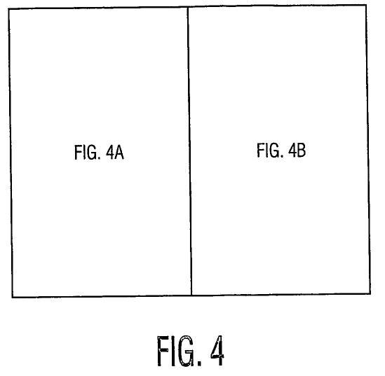

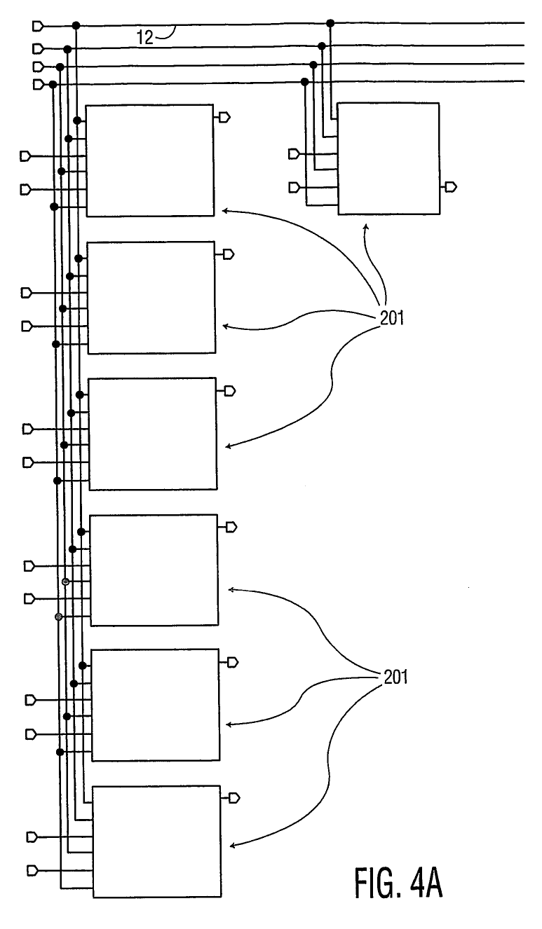

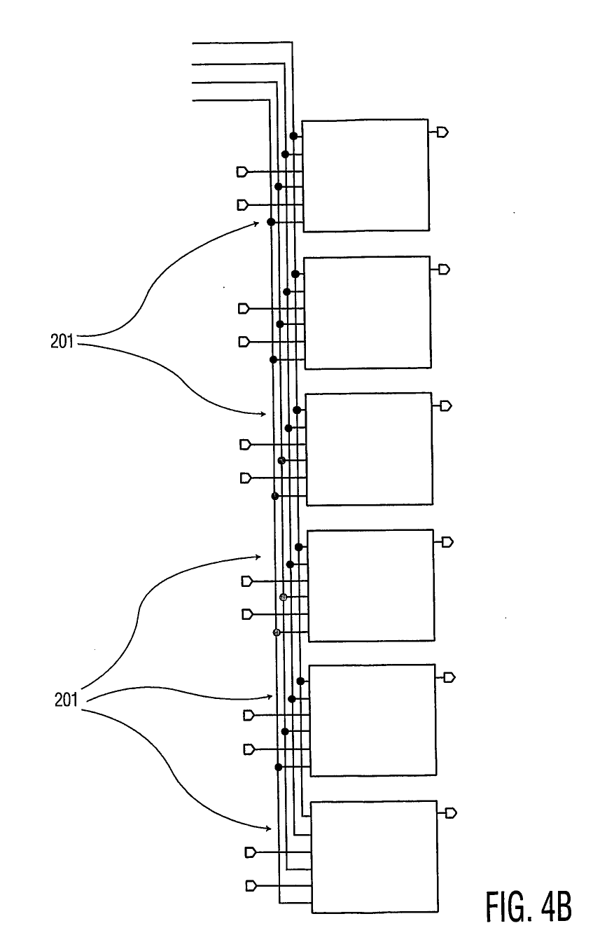

FIG. 4 is a circuit diagram depicting the line memory components comprising the vertical delay block memory module 101 depicted in FIG. 3;

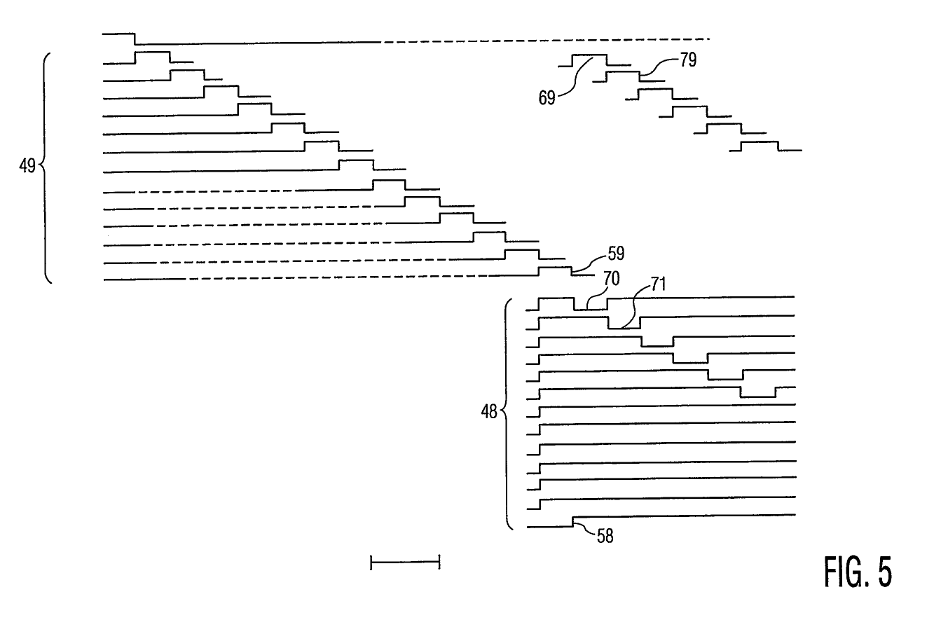

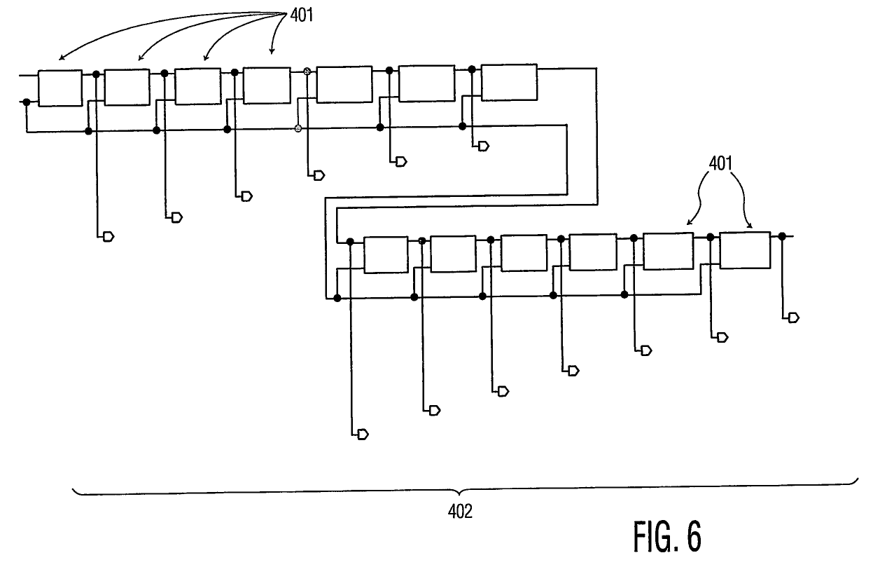

FIG. 5 illustrates the timing of the line memory read and write pulses operating to control acquisition of data for the kernel;

FIG. 6 illustrates a detailed diagram of the horizontal delay circuit 22 depicted in FIG. 1;

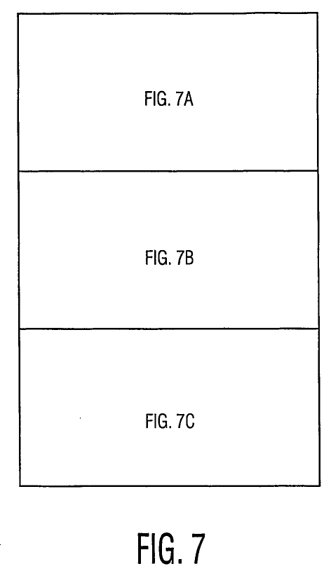

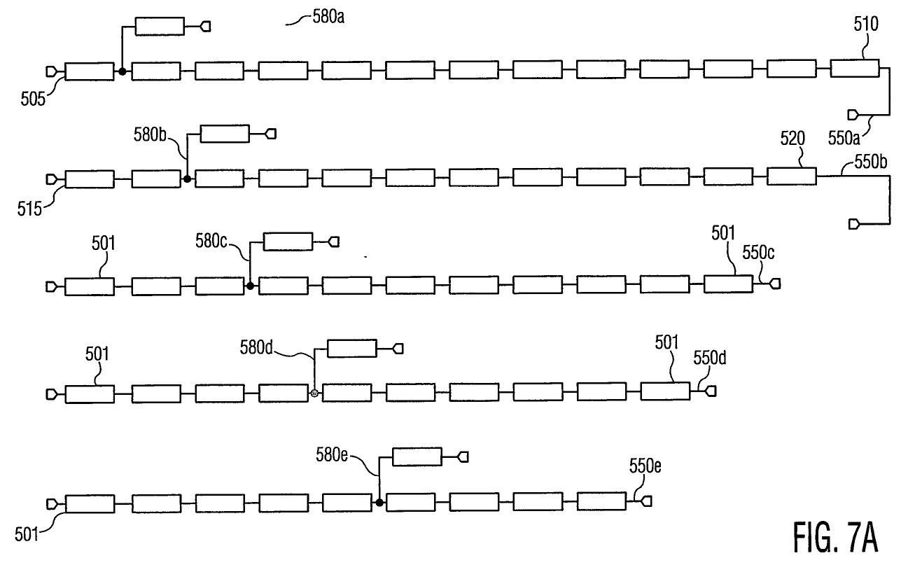

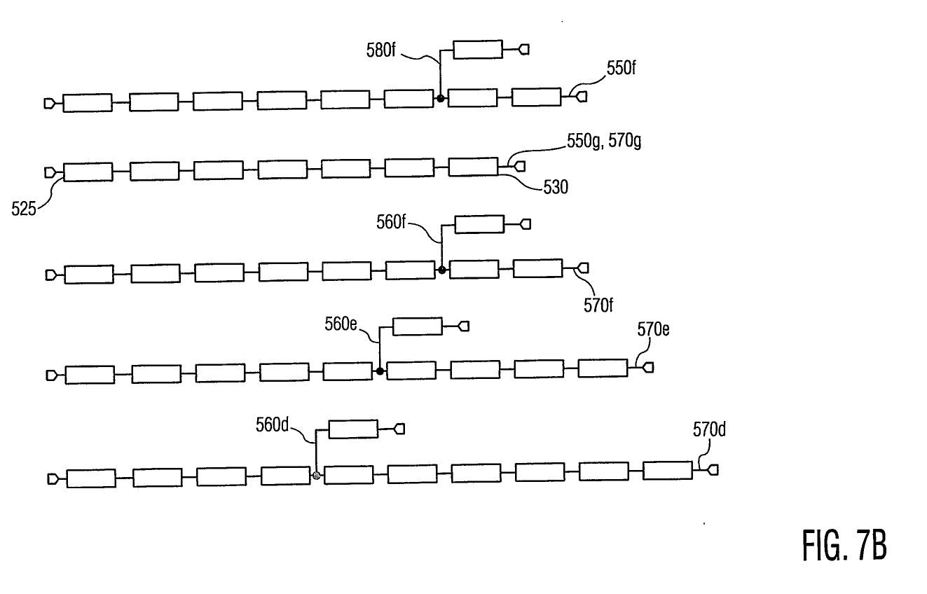

FIG. 7 depicts the organization of the diagonal delay circuit 33 of FIG. 1 that may be used to generate the diagonal data for the kernel;

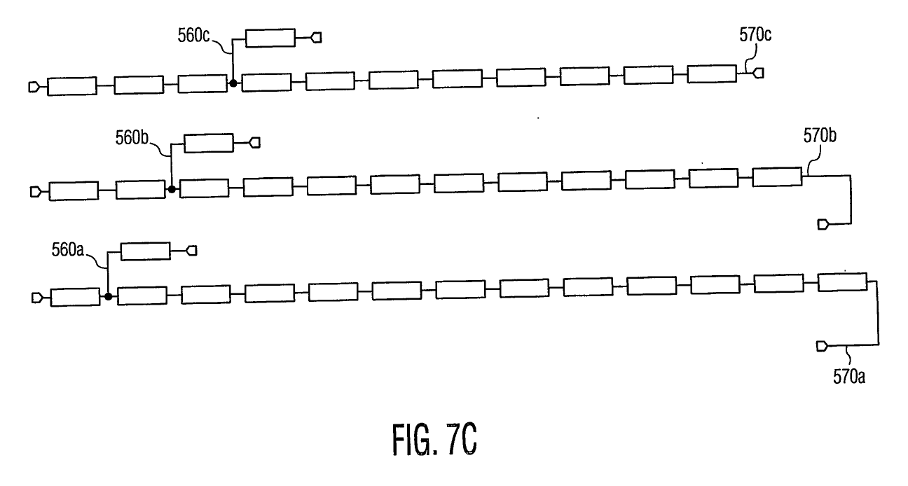

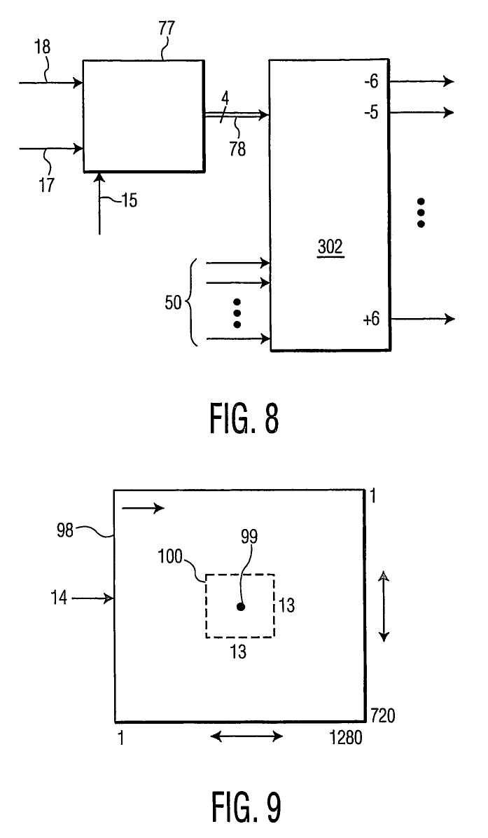

FIG. 8 illustrates an exemplary circuit for ensuring the vertical data of the kernel is output at the multiplexer at the correct sequence (this is the ‘inside’ of block 302, 2 FIG. 2); and,

FIG. 9 illustrates an example display 98 comprising pixels of a video frame at a predetermined resolution, and depicting a kernel 100 about a base pixel 99 therein.

FIG. 1 depicts a generic block diagram 10 of the hardware approach for real time 2D video processing 10 according to the invention. For purposes of description, the present invention is implemented in a high definition television system, implementing, for example, the 720P (Progressive) broadcasting video standard. In the 720P standard there are 720 vertical lines, with each line having 1280 active pixels, however, it is understood that additional information, including horizontal and vertical blanking intervals increase the total number of pixels (e.g., 1650×750). According to the typical television video broadcasting standard, the video image data enters the system line by line in the vertical direction from top to bottom of the video frame with line scanning performed left to right in the horizontal direction. FIG. 1 depicts video image data entering the system 10 as a one-dimensional data stream 12.

In the video processing algorithm according to the invention, calculations are required to be performed in four directions (horizontal, vertical and two diagonal (e.g., +/45°)) within a block. This block of pixels, alternately referred to herein as a kernel, is of a size M×N, for example, where M is the kernel's horizontal and N is the kernel's vertical size. Note, for purposes of description M=N and, as shown in FIG. 1, an example 13×13 video image block is depicted. It is understood however, that the invention is applicable to other M×N 2D kernel sizes, and preferably, a size where M and N are odd values, since the kernel is symmetrical around a base pixel where the edge determination is performed.

In the exemplary system 10 depicted in FIG. 1, there is provided four ‘arithmetic’ blocks labeled ‘A’, ‘B’, ‘C’, ‘D’, that perform the processing calculations in parallel. Preferably, each of these blocks ‘A’, ‘B’, ‘C’, ‘D’ perform the calculations in a single direction of pixels, e.g., vertical (block A), horizontal (block B), +/−45° (blocks C, D), respectively, and determine the existence of an edge at the base pixel. Preferably, if an edge is found, each of these blocks additionally determines edge parameters such as width, dynamic range, transition direction, etc. Thus, in FIG. 1, in order for these ‘arithmetic’ calculator blocks to be identical and work in parallel (also synchronously), the data streams entering these blocks must have the same format and be synchronized according to a common time clock 15.

To achieve the above similarity of the data streams for parallel processing according to the hardware realization of the invention, a pixel rearrangement structure is provided. Such a structure comprises a vertical source block ‘11’ (FIG. 1) for receiving successive scanned video data lines according to the typical broadcasting standard, each received line comprising a 1 dimensional data stream 12 of the video frame. After receiving an amount of data from the video lines, the vertical source block ‘11’ builds a M×N (e.g., 13×13) pixel block or kernel which is processed for generating the parallel streams used by the calculator blocks ‘A’, ‘B’, ‘C’, ‘D’. As will be explained in further detail, the vertical source block ‘11’ includes a vertical delay block ‘301’ and a line multiplexer ‘302’, configured in the manner as depicted in FIG. 2. The vertical delay block ‘301’ comprises a memory module ‘101’ and a memory controller ‘102’ configured in the manner as depicted in FIG. 3. The memory module ‘101’ includes N line memories ‘201’ configured in the manner as depicted in FIG. 4. As will be described, the vertical source block ‘11’ including line memories are necessary because information to calculate the edge at a base pixel within the kernel requires information for lines that have already been received and lines not yet received. Particularly, the memory in vertical source block ‘11’ is necessary to store the video pixel information for lines in the kernel which have already been received, in the exemplary case of a 13×13 kernel, pixel data from each of six (6) lines 20 up (before) the video data line 30 including the base pixel, and video pixel data for six (6) successive lines 40 down (after) the line 30 including the base pixel in the kernel which will subsequently be received. Thus, in the example embodiment, the 13 lines of pixel information are stored in the line memories residing in the vertical delay block 301 of FIG. 2 in order to build the kernel.

As now described with reference to FIGS. 2 and 3, the vertical delay block 301 includes memory controller 102 and memory module 101. The line memories' performance is controlled by the line memory controller 102 which receives control signals including the vertical blank (V_blank) signal 18 and horizontal blank (H_blank) signal 17 and the clock 15. The vertical delay block memory module 101 includes the line memories such as shown in FIG. 4. The line memories' performance is controlled by the line memory controller 102 in the following manner: after the vertical blanking interval, i.e., receipt of the V_blank reset pulse 18, the received H-blank pulses 17 are counted so that it is known exactly where in the vertical direction of a frame the current active video line information is being received. Thus, after the vertical blanking interval, and following receipt of the H_blank pulse corresponding to the vertical location in the video frame having the 1^{st} active line of a kernel for a desired base pixel, all the 1^{st} active video line data of that kernel is written in line memory_1 201, labeled U1 in FIG. 4. In the example embodiment of a 13×13 kernel described herein, this location is six (6) lines up from the line 30 that includes the base pixel as shown in FIG. 1. Immediately following receipt of the next H_blank pulse 17, the 2^{nd} line of the kernel (e.g., five lines (5) up from the base line 30 in the example embodiment) is written into line memory_2 201, labeled U2 in FIG. 4, and this process continues, etc., until the Nth line is written into memory N, labeled U13 in FIG. 4 (e.g., six lines (6) below the base line 30 in the example embodiment). It is understood that the N+1th line is written into memory 1, N+2th line into memory 2, etc. as the video scanning progresses. That is, in the preferred embodiment, the reading operation starts with the start of the Nth line as all data from lines 1 through N−1 of the kernel is stored and available for processing. Thus, the data from memories 1 to N−1 are read in parallel during the writing of the data at the Nth active video line. Then, during writing of the N+1th active video line the line memories 2 to N are read, during N+2th line the line memory 1 and line memory 3 to line memory N are read, etc. Note, that the line memory, which is in active ‘write’ state during a particular line time is not read out during that line time as illustrated in FIG. 5.

Particularly, as shown in FIG. 3, memory control block 102 generates respective read pulses 48 and write pulses 49 for controlling read and write operations of the line memories 201 (e.g., U1-U13 of FIG. 4) of the memory module 101. The timing of these line memory write pulses labeled WR1-WR13 are depicted in the exemplary embodiment of FIG. 5, with the first active line write pulse WR1 (for writing data of active video line 1 of the kernel) shown immediately following receipt of a V_blank pulse, and the next successive active line write pulse WR2 triggered at the falling edge of the prior (WR1) pulse. As may be known to skilled artisans, this process may be controlled by an H_blank pulses counter. This process is repeated for each subsequent write pulse until WR13 is generated, as shown in FIG. 5. It is understood that in FIG. 5, the duration of the pulse corresponds to one line time. As depicted in FIG. 5, once active line N (e.g., N=13) is being read as depicted by pulse 59, the data at line memories 1 through N−1 are being simultaneously read (in parallel) as indicated by the triggering of respective read pulses RD1-RD12 depicted as lines 48. In the next kernel shift, as new line N+1 is being written to the line memory 1 as depicted by WR1 pulse 69, the data at line memories 2 through N are being simultaneously read (in parallel) as indicated by the active high state of respective read lines 48 (RD2-RD12) and the triggering of read pulse RD13 depicted as pulse 58. It is understood that, for the write duration to line memory 1 for the new line N+1, the reading of line memory 1 is prevented by the state change depicted as the active low state 70. The process continues as each subsequent line is being written into line memories and the data lines 48 are being read in parallel. Thus, for the next kernel shift, line N+2 is read into the line memory 2 as controlled by pulse 79, and the read pulses for line memory modules 1 and 3 through N are active and the corresponding data stored therein read out in parallel. It is understood that reading of line memory 2 is now prevented by the state change depicted as the active low state 71, etc. It should be understood that the duration of the ‘read’ and ‘write’ pulses may also be equal to the active part of the video line, thus preserving the memory length, i.e., the blanking part is not stored. This will require a more sophisticated ‘Memory control’ block. However, if this approach is taken, the ‘border’ pixels from the 1^{st} to the 5^{th} on all sides of the video frame will have a non-symmetrical kernel. Ideally, for these pixels the data is ‘mirrored’, i.e., available data is symmetrically copied to the missing locations, which will require even more sophisticated controls. In the present example described, the data from the blanking part may be used in those ‘border’ kernels, which, is acceptable for most of the consumer systems because of the ‘overscan’, i.e., when the visible part of the image is slightly less by a couple of pixels, than the total picture resolution.

Referring back to FIG. 2, the line multiplexer block 302 receives the stored vertical data 50 which is output from the line memories 201 of the vertical delay block memory module 101 (FIG. 3) in parallel. Preferably, the line multiplexer 302 re-arranges the line sequence so that the data input to the ‘arithmetic’ block always receives the current incoming line as the bottom line (e.g., N=13 or base +6); the line stored in the previous line period as the one line above it (e.g., N=12 or base +5), and so on, such that the line stored N−1 line times before (e.g., line N=1 or base line −6) appears as the most top line regardless from which particular line memory the data is read out. Thus, due to shifting of the write and read points under memory control described with respect to FIG. 5, the line multiplexer 302 ensures that the data is output always at the correct sequence and that the block (kernel) smoothly moves in the vertical direction. For an example embodiment, as shown in FIG. 8, this operation (actually, as well as others) may be coded in HDL and may include a simple counter device 77 receiving H_blank 17, V_blank 18 and clock 15 signals to generate an output 78 that control multiplexer operations necessary to achieve this.

It should be understood that the vertical source block ‘11’ processing is a real-time, continuous process such that the base pixel, and consequently the kernel, and the availability of 2D pixel information therein for determining edges at base pixels, constantly changes with each successive scan in the vertical direction as performed by the video processing system of a particular display device.

Having performed the real-time process described herein with respect to FIGS. 2-5, a vertical line of pixels is now available with the top line corresponding to the base line −6 lines of the block (kernel) and the bottom line corresponding to the base line +6 lines, for the example embodiment described. From this vertical line of pixels, the generation of the horizontal and diagonal lines is performed in real time as follows:

Particularly, as depicted in FIG. 1, a base pixel (at location N=7 of the pixel kernel) that is received from each vertical line of the kernel form a horizontal line. Thus, a horizontal line may be formed, which is the center line of the kernel in vertical direction is called the base line and it contains the all ‘base’ pixels. To create the data sequence around the ‘base’ pixel in the horizontal direction, the data of this base line is input from bus 16 to horizontal delay circuit 22 where the pixels are delayed, so that base pixel of interest corresponds to the middle of the horizontal line. FIG. 6 illustrates a detailed diagram of the horizontal delay circuit 22, which comprises a shift register with serial load and parallel unload including M (e.g., M=13) delay circuits connected serially, with each delay comprising one D flip-flop 401. Each of the registers has an output 402 to the corresponding ‘arithmetic’ block B as shown in FIG. 1.

To create the two diagonal (e.g., +/−45°)) sequences each output of the vertical source block 11 is fed as signals 19 into a diagonal source block 33 in FIG. 1. As depicted in FIG. 7, diagonal source block 33 comprises a M×N configuration of shift registers, each including one-clock delay ‘501’. It is understood that, in a generic case, when M≠N (not a square kernel), the length of the diagonal will be the smallest of M and N. Consequently, all the following formulas would be changed accordingly as would be within the purview of skilled artisans. The shift registers 501 are connected serially for delay every clock cycle, with the amount of registers in the first row from the 1^{st} register 505 to the Nth register 510 is M, the amount of registers in the second row from register 515 to the N−1th register 520 is M−1, etc. The length of the center row comprises a serial connection of (M+1)/2 in the example embodiment of M=N=13, i.e., a serial connection from register 525 to the (N+1)/2th register 530. To create the diagonal sequence in the +45 degrees direction the outputs 550a through 550g of the last one-clock delay of shift registers from 1 to (M+1)/2 are taken together with the output 560a of the first delay of the Nth shift register, the output 560b of the second delay of the N-1th shift register, the output 560c of the third delay of the N−2th shift register, and so on, until the output 560f of register (M+3)/2 is obtained. Likewise, for the −45 degrees diagonal, direction the outputs 570a-570g of the last delays of shift registers N to (M+1)/2 (register 530) are taken together with the output 580a of the first delay of the 1^{st} shift register 505, the output 580b of the second delay of the 2^{nd} shift register, the output 580c of the third delay of the 3rd shift register, and so on, including register 580f. As described herein, the outputs 550a-550g, 560a-560f and 570a-570g, 580a-580f of the respective two diagonal (i.e., +/−45°)) sequences generated by the diagonal source block 33 are available as 2D information synchronized for simultaneous parallel output for edge detector calculator block ‘D’ as depicted in FIG. 1.

Further in FIG. 1, it should be understood that a vertical data delay block ‘44’ is provided in order to delay the output of the vertical source block ‘1’ by (M+1)/2 clock cycles to align the 2D vertical source parallel data with the 2D horizontal parallel data and the 2D diagonal parallel data outputs for simultaneous input to the arithmetic blocks ‘A’ to ‘D’.

While there has been shown and described what is considered to be preferred embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

1. A hardware apparatus for generating synchronous multidimensional data streams from a one-dimensional data stream comprising:
means for receiving successive scanned lines of video data of a video frame to be displayed, each received line of video data comprising a one-dimensional stream of pixel data, and a predetermined number M of pixels from each of N successive lines forming a two-dimensional kernel that includes a horizontal base line including a base pixel;
vertical data processing means for successively storing pixel data from said successively received lines of a kernel and generating for successive output N pixel data in parallel form, said N parallel pixel data generated comprising vertically aligned pixel data from each said N lines including a vertical line of pixel data from said kernel including said base pixel;
horizontal data processing means for successively receiving pixel data from a single line of each successive vertically aligned parallel pixel data output from said vertical data processing means, said received pixel data corresponding to said base line including said base pixel, said horizontal data processing means generating for successive output M pixel data in parallel form comprising pixel data belonging to a horizontal base line of said kernel;
diagonal data processing means for successively receiving pixel data from each successive vertically aligned parallel pixel data output from said vertical data processing means and generating for successive output pixel data in parallel form comprising pixel data belonging to first and second diagonals of said kernel, said first and second diagonal including said base pixel; and,
timing means for enabling synchronized output of a vertical line parallel data, horizontal base line parallel data and first and second diagonal parallel data each comprising said base pixel of said kernel, to enable subsequent real-time processing of a video image at said base pixel.

2. The hardware apparatus according to claim 1, wherein the kernel comprises an M×N matrix of pixels symmetrical about said base pixel.

3. The hardware apparatus according to claim 2, wherein M=N.

4. The hardware apparatus according to claim 2, wherein said timing means includes means for delaying said output of said vertical data processing means by (M+1)/2 clock cycles to align the vertical line parallel data including said base pixel with said the horizontal base line parallel data and diagonal parallel data outputs.

5. The hardware apparatus according to claim 2, wherein said vertical data processing means comprises:
N memory storage devices for successively storing pixel data from a corresponding line of said N successively received scanned video lines; and,
memory controller for controlling writing of received one-dimensional scanned pixel data line to a respective said memory storage device and, reading of data from each of said N memory storage devices to form said N pixel data parallel outputs, each N pixel data parallel output generated in a successive clock cycle.

6. The hardware apparatus according to claim 5, wherein said memory controller includes means for enabling simultaneous reading of data from each of a 1^{st} memory storage device through said N-1th memory storage device as pixel data of said Nth scanned video line is written to said Nth memory storage device.

7. The hardware apparatus according to claim 6, wherein said kernel is successively shifted for processing at a new base pixel at receipt of each successive scanned line after said Nth video line, said memory controller enabling writing of pixel data of a received N+1th scanned video line in said 1^{st} memory storage device while enabling simultaneous reading of data from each of a 2^{nd} memory storage device through said Nth memory storage device.

8. The hardware apparatus according to claim 6, wherein at each kernel shift, each successive input line N+X line is read into a corresponding numbered line memory X of said N memory storage device, where 1≦X<N, while corresponding data stored in remaining memory storage devices exclusive of said line memory X is read out in parallel.

9. The hardware apparatus according to claim 8, wherein said vertical data processing means further comprises:
means for receiving the data read from each of said N memory storage devices; and,
means for re-arranging the line sequence so that the vertical line parallel data output from said vertical data processing means is arranged such that the received incoming line X received in sequence (where 1≦X<N) is output as a corresponding line X of said N parallel output lines regardless from which particular line memory storage device the corresponding pixel data is read out.

10. The hardware apparatus according to claim 9, wherein said means for re-arranging the line sequence includes a multiplexer device for ensuring that the data is output always at the correct sequence and that a kernel shifts in the vertical direction.

11. The hardware apparatus according to claim 10, wherein said means for re-arranging the line sequence further comprises a counter device for receiving H_blank pulses at its clock input to ensure that the N parallel output line data is output at the correct sequence.

12. The hardware apparatus according to claim 1, wherein the number of pixel data output in parallel form from said diagonal data processing means is the smallest of M and N.

13. A method for making video data available for real time processing comprising the steps of:
a) receiving successive scanned lines of video data of a video frame to be displayed, each received line of video data comprising a one-dimensional stream of pixel data, and a predetermined number M of pixels from each of N successive lines forming a two-dimensional kernel that includes a horizontal base line including a base pixel;
b) successively storing pixel data from said successively received lines of a kernel and generating for successive output N pixel data in parallel form, said N parallel pixel data generated comprising vertically aligned pixel data from each said N lines including a vertical line of pixel data from said kernel including said base pixel;
c) successively receiving pixel data from a single line of each successive vertically aligned parallel pixel data output, said received pixel data corresponding to said base line including said base pixel,
d) generating for successive output M pixel data in parallel form comprising pixel data belonging to a horizontal base line of said kernel;
d) successively receiving pixel data from each successive vertically aligned parallel pixel data output from said vertical data processing means;
e) generating for successive output pixel data in parallel form comprising pixel data belonging to first and second diagonals of said kernel, said first and second diagonal including said base pixel; and,
f) synchronizing output of a vertical line parallel data, horizontal base line parallel data and first and second diagonal parallel data each comprising said base pixel of said kernel, to enable subsequent real-time processing of a video image at said base pixel.

14. The method according to claim 13, wherein said step b) of successively storing pixel data from said successively received lines of a kernel includes the step of:
successively storing pixel data from a line of said N successively received scanned video lines in a corresponding device of N memory storage devices; and,
writing a received one-dimensional scanned pixel data line to a respective said memory storage device; and,
reading data from each of said N memory storage devices to form said N pixel data parallel outputs, each N pixel data parallel output generated in a successive clock cycle.

15. The method according to claim 13, including the steps of enabling simultaneous reading of data from each of a 1^{st} memory storage device through said N-1th memory storage device while writing of pixel data of said Nth scanned video line into said Nth memory storage device.

16. The method according to claim 15, wherein said kernel is successively shifted for video processing at a new base pixel at receipt of each successive scanned line after said Nth video line, said method including the steps of:
writing pixel data of a received N+1th scanned video line into said 1^{st} memory storage device; and
simultaneously reading of data from each of a 2^{nd} memory storage device through said Nth memory storage device.

17. The method according to claim 15, wherein at each kernel shift, the steps of:
reading each successive input line N+X into a corresponding numbered line memory X of said N memory storage devices, where 1≦X<N, and,
simultaneously reading out in parallel the corresponding data stored in remaining memory storage devices exclusive of said line memory X.

18. The method according to claim 17, further comprising the steps of:
receiving the data read from each of said N memory storage devices prior to parallel output; and,
re-arranging the line sequence so that the vertical line parallel data output is arranged such that the received incoming line X received in sequence (where 1≦X<N) is output as a corresponding line X of said N parallel output lines regardless from which particular line memory storage device the corresponding pixel data is read out.

19. The method according to claim 13, wherein the number of pixel data output in parallel form comprising pixel data belonging to first and second diagonals of said kernel is the smallest of M and N.

20. A video display device including hardware apparatus for making video data available for real time processing, said apparatus comprising:
means for receiving successive scanned lines of video data of a video frame to be displayed, each received line of video data comprising a one-dimensional stream of pixel data, and a predetermined number M of pixels from each of N successive lines forming a two-dimensional kernel that includes a horizontal base line including a base pixel;
vertical data processing means for successively storing pixel data from said successively received lines of a kernel and generating for successive output N pixel data in parallel form, said N parallel pixel data generated comprising vertically aligned pixel data from each said N lines including a vertical line of pixel data from said kernel including said base pixel;
horizontal data processing means for successively receiving pixel data from a single line of each successive vertically aligned parallel pixel data output from said vertical data processing means, said received pixel data corresponding to said base line including said base pixel, said horizontal data processing means generating for successive output M pixel data in parallel form comprising pixel data belonging to a horizontal base line of said kernel;
diagonal data processing means for receiving pixel data from each successive vertically aligned parallel pixel data output from said vertical data processing means and generating for successive output pixel data in parallel form comprising pixel data belonging to first and second diagonals of said kernel, said first and second diagonal including said base pixel; and,
timing means for enabling synchronized output of a vertical line parallel data, horizontal base line parallel data and first and second diagonal parallel data each comprising said base pixel of said kernel, to enable subsequent real-time processing of a video image at said base pixel.
